(19) United States
(12) Patent Application Publication
(10) Pub. No.: US 2023/0417194 A1
(43) Pub. Date: Dec. 28, 2023

(54) METHOD FOR CONTROLLING A TURBOMACHINE COMPRISING AN ELECTRIC MOTOR

(71) Applicant: SAFRAN AIRCRAFT ENGINES, Paris (FR)

(72) Inventor: Cedrik Djelassi, Moissy-Cramayel (FR)

(73) Assignee: SAFRAN AIRCRAFT ENGINES, Paris (FR)

(21) Appl. No.: 18/253,375

(22) PCT Filed: Nov. 12, 2021
(86) PCT No.: PCT/EP2021/081590

§ 371 Date: May 17, 2023

(30) Foreign Application Priority Data
Nov. 27, 2020 (FR) FR2012245

(51) Int. Cl. F02C 9/28; F02C 9/48

(52) U.S. Cl. CPC F02C 9/28; F02C 9/48

(57) ABSTRACT

The invention relates to a method for controlling a turbine engine having an electric motor forming a device for injecting torque on the high-pressure rotation shaft, in which method a setpoint for fuel flow into the combustion chamber and a setpoint for torque supplied to the electric motor are determined, the control method having: a step of determining a temperature correction value as a function of a temperature parameter of the gases leaving the turbine engine and a maximum value of the temperature parameter of the gases leaving the turbine engine, a step of determining a torque correction value as a function of the temperature correction value and a step of determining the torque setpoint as a function of the torque correction value.

### TECHNICAL FIELD

The present invention relates to an aircraft turbomachine, in particular, the control of a turbomachine in order to provide the desired thrust according to the position of the joystick of the aircraft pilot,

With reference to [FIG. 1], a turbomachine 100 of the twin shaft turbofan type is schematically represented. In a known manner, the turbomachine 100 comprises, from upstream to downstream in the gas flow direction, a fan 110, a low pressure compressor 111, a high pressure compressor 112, a combustion chamber 113 which receives a fuel flow set point WF_{CMD}, a high pressure turbine 114, a low pressure turbine 115 and a primary exhaust nozzle 116. The low pressure (or LP) compressor 111 and the low pressure turbine 115 are connected by a low pressure shaft 121 and together form a low pressure body. The high pressure (or HP) compressor 112 and the high pressure turbine 114 are connected by a high pressure shaft 122 and together form, with the combustion chamber, a high pressure body. The fan 110, which is driven by the LP shaft 121, compresses the ingested air. This air is divided downstream of the fan 110 between a secondary air flow which is directed directly to a secondary nozzle (not represented) through which it is ejected to contribute to the thrust provided by the turbomachine 100, and a so-called primary flow which enters the gas generator, constituted by the low pressure body and the high pressure body, and which is then ejected into the primary nozzle 116. In a known manner, to modify the engine speed of the turbomachine 100, the aircraft pilot modifies the position of a joystick which allows the fuel flow set point WF_{CMD} to be modified in the combustion chamber 113.

The design of a turbomachine 100 requires taking into account a sufficient margin against the so-called pumping phenomenon. This phenomenon, which results from an excessive impact of the air flow on the blades of one of the compressors, results in large and rapid fluctuations in the pressure downstream of the compressor concerned and can lead to an extinction of the combustion chamber 113. It further generates severe jolting of the compressor blades and can thus lead to mechanical damage. It is therefore particularly important to prevent it from occurring. The operation of a compressor in use is generally represented by a diagram which expresses the pressure ratio obtained between the outlet and the inlet, as a function of the air flow passing through it; this diagram is further parameterized as a function of the rotation speed of the compressor. This diagram shows a pumping line which constitutes the maximum limit in compression ratio not to be exceeded, to avoid the risk of a pumping phenomenon occurring. In a known manner, a line is defined, known as an operating line, associating the compression ratios obtained as a function of the flow rate, when the turbomachine 100 is in stabilized operation. The positioning of this operating line is left to the discretion of the turbomachine 100 designer and the distance from this operating line to the pumping line represents the pumping margin. It should be noted that the efficiency of the compressor (compression work supplied to the air, in relation to the work supplied to drive it in rotation) is, as a first approximation, better as the pumping line is approached. Conversely, the accelerations requested by the pilot from a stabilized operation (transient phase) to obtain an increase in thrust, are reflected at the level of the compressor by an excursion of the operating point which takes place in the direction of the pumping line.

Indeed, an additional injection of fuel into the combustion chamber 113 causes the compression ratio to rise almost instantaneously, whereas the rotational engine speed does not have the time to increase due to inertia. The enthalpy variation provided to the fluid by the combustion of the added fuel then results in an increase in the work supplied by each turbine and, consequently, an increase in the rotational speed of the corresponding body. This is reflected at the level of the compressor diagram by a return of the operating point to the operating line when the engine speed stabilizes again, at an operating point that corresponds to a higher flow rate than that of the previous operating point.

The designer of a turbomachine 100 must therefore try to optimize the positioning of the operating line by placing it as high as possible, so as to benefit from better efficiency for its compressors, while maintaining a sufficient distance with respect to the pumping line to enable safe accelerations.

In order to avoid any pumping phenomenon, a turbomachine 100 comprises a regulation system implemented by an electronic unit. With reference to [FIG. 2], the regulation system comprises a stabilized management module 31, a transient intention detection module 32, an engine speed trajectory generation module 33, a selection module 34, an integration module 35 as well as a stop management module 36.

The stabilized management module 31 supplies a correction variable to the selection module 34 as a function of the difference between the engine speed NL of the turbomachine 100 and the set point engine speed NL_{CONS}. The engine speed NL may correspond to different types of engine speed, notably a fan speed, a pressure set point known as the EPR (Engine Pressure Ratio), a high pressure set point or other.

The set point engine speed NL_{CONS} is proportional to the position of the joystick that can be handled by the aircraft pilot. Such a stabilized management module 31 is known to those skilled in the art and will not be presented in more detail.

The purpose of the transient intention detection module 32 is to detect a transient intention desired by the pilot. The transient intention detection module 32 determines a difference between the engine speed NL of the turbomachine 100 and the set point engine speed NL_{CONS}. When the joystick remains in a constant position and the stabilized management module 31 is implemented, the actual engine speed NL of the turbomachine 100 is stationary and equal to the set point engine speed NL_{CONS}. If the pilot moves the joystick, the set point engine speed NL_{CONS} varies instantly. On the contrary, the engine speed NL does not vary instantly due to the inertia of the turbomachine 100 and the stabilized management module 31. Thus, the transient intention detection module 32 detects a transient intention when the difference between the set point engine speed NL_{CONS} and the actual engine speed NL is greater than a predetermined threshold S2.

In the case of an acceleration request, if the engine speed difference is greater than the predetermined threshold S2 (NL_{CONS}−NL>S2), an acceleration request is detected. Similarly, in the case of a deceleration, if the engine speed difference is greater than the predetermined threshold S2 (NL−NL_{CONS}>S2), a deceleration request is detected. When a transient phase is detected, the transient intention detection module 32 generates an activation signal, which is transmitted to the engine speed trajectory generation module 33 and the selection module 34 as illustrated in [FIG. 2].

In the case of an acceleration request, the engine speed trajectory generation module 33 determines an engine speed set point for the acceleration (acceleration trajectory). Similarly, in the case of a deceleration, the engine speed trajectory generation module 33 determines an engine speed set point for the deceleration (deceleration trajectory). As a function of the trajectory generated, the engine speed trajectory generation module 33 supplies a correction variable to the selection module 34.

Such an engine speed trajectory generation module 33 is known to those skilled in the art, in particular by patent application US2013/0008171 and patent application FR2977638A1, and will not be presented in more detail.

In this example, when the selection module 34 receives an activation signal from the transient intention detection module 32, the selection module 34 selects the correction variable from the stabilized management module 31 in the absence of reception of an activation signal and selects the connection variable from the engine speed trajectory generation module 33 in the case of reception of an activation signal. Such a selection module 34 is known to those skilled in the art and will not be presented in more detail. The selected correction variable is supplied to the integration module 35. The integration module 35 determines the fuel flow set point WF_{CMD} by integrating the selected correction variable.

The stop management module 36 limits the value of the fuel flow set point WF_{CMD} determined by the integration module 35. In a known manner, the stop management module 36 implements a stop, called C/P stop, known to those skilled in the art in order to protect the turbomachine against pumping. In this example, the stop management module 36 makes it possible to define stop set points in acceleration and deceleration. Such stops are known to those skilled in the art and will not be presented in more detail.

The engine speed trajectory generation module 33 and the stop management module 36 make it possible to define an acceleration trajectory which has the consequence of limiting the fuel flow set point WF_{CMD} in order to avoid pumping. Such a regulation system is known by patent application FR2977638A1 and will not be presented in more detail. Incidentally, it is known to protect an engine against the pumping phenomenon during transients by considering an acceleration set point during regulation (see for example U.S. Pat. No. 4,543,782 and US 2003/0094000).

Such a regulation system is efficient but does not allow the temperature of the gases at the turbomachine outlet to be controlled, known as the EGT temperature for “Exhaust Gas Temperature”, so that it does not exceed a limit temperature EGTmax.

In order to eliminate this drawback, an immediate solution would be to provide an independent regulation method dedicated to the temperature of the gases at the outlet of the turbomachine, but this has numerous drawbacks in terms of performance (latency, error, etc.).

### SUMMARY

The invention relates to a method for controlling a turbomachine comprising a fan positioned upstream of a gas generator and delimiting a primary flow and a secondary flow, said gas generator being crossed by the primary flow and comprising a low pressure compressor, a high pressure compressor, a combustion chamber, a high pressure turbine and a low pressure turbine, said low pressure turbine being connected to said low pressure compressor by a low pressure rotating shaft and said high pressure turbine being connected to said high pressure compressor by a high pressure rotating shaft, the turbomachine comprising an electric motor forming a torque injection device on the high pressure rotating shaft, method wherein a fuel flow set point in the combustion chamber and a torque set point supplied to the electric motor are determined, the control method comprising:
a step of determining a temperature correction variable as a function of a turbomachine outlet gas temperature parameter and a maximum value of the turbomachine outlet gas temperature parameter,
a step of determining a torque correction variable as a function of the temperature correction variable, and
a step of determining the torque set point as a function of the torque correction variable.

Thanks to the torque injection of the electric motor, it is possible to maintain optimum performance while significantly reducing the temperature of the exhaust gases. The electric motor thus makes it possible to avoid degrading the thrust performance to maintain a sufficient temperature margin.

Preferably, the control method comprises:
a step of implementing a first fuel regulation loop in order to determine the fuel flow set point comprising:
   a step of detecting an engine speed transient intention as a function of a difference between a current engine speed and a determined engine speed set point,
   a step of determining a transient engine speed set point,
   a step of determining a fuel correction variable as a function of the transient engine speed set point and
   a step of determining the fuel flow set point as a function of the fuel correction variable,
a step of implementing a second torque regulation loop in order to determine the torque set point comprising
   a step of determining a torque correction variable as a function of the transient engine speed set point and the temperature correction variable.

Thanks to the invention, the temperature of the outlet gases is regulated while maintaining margins to avoid pumping or an extinction of the turbomachine. The step of detecting an engine speed transient intention corresponds to a thrust transient intention. In this way, the current engine speed of the turbomachine can follow the trajectory set point reactively. The operability of the turbomachine is thus improved. Advantageously, the step of determining a temperature correction variable makes it possible to use the electric motor to limit the temperature of the gases at the turbomachine outlet. The temperature regulation is therefore directly integrated into the step of determining a torque correction variable.

Preferably, during the step of determining a torque correction variable, in the case of acceleration, the maximum value is selected between the temperature correction variable and an acceleration correction variable determined from the acceleration transient speed set point. In other words, during an increase of the acceleration leading to a temperature increase, the maximum correction variable is selected in order to obtain the desired acceleration while limiting the temperature of the outlet gases. Thus, the temperature regulation is fully integrated into the overall regulation, which guarantees optimal performance.

In this example, the maximum correction variable is selected in the case of a positive sign convention for a driving torque control and a negative control for a braking torque control. Conversely, the minimum correction variable is selected in the case of a negative sign convention for a driving torque control and a positive control for a braking torque control.

Advantageously, the second torque regulation loop does not replace the first fuel regulation loop but supports it when operating limits are reached. The fundamentals of the regulation of the engine speed is thus not upset, which ensures reliable regulation.

The invention also relates to a control method as set forth previously, comprising:
a step of activating a temperature protection control by comparing the turbomachine outlet gas temperature parameter with the maximum value of the turbomachine outlet gas temperature parameter reduced by a predetermined adjustment threshold
a step of activating the temperature correction variable when the temperature protection control is activated.

Preferably, the method comprises during the step of implementing the second torque regulation loop, a step of resetting to zero the torque set point, the step of resetting to zero the torque set point being inhibited in the case of activation of the temperature protection control.

Advantageously, the control method comprises a step of resetting to zero the torque set point which is implemented continuously but inhibited when the fuel set point control limits are reached. In other words, the electrical torque is not used continuously in order to avoid excessive electrical power consumption. The electrical torque is injected into the high pressure shaft when the fuel set point regulation limits are reached (pumping, extinction, EGT temperature, etc.) in order to allow them to be offset. In other words, when it is injected, the electrical torque makes it possible to offer a regulation margin to the first fuel regulation loop. Once this margin is obtained, the torque set point can be reset to zero, in particular progressively.

Preferably, the torque set point is progressively reset to zero, preferably according to at least one reduction gradient. A progressive reset to zero opposes a sudden reset to zero which would cause disturbances in the engine speed of the turbomachine. A progressive reset to zero according to a reduction gradient makes it possible to control the speed at which the second torque regulation loop reduces its influence in order to allow the first fuel regulation loop to regain its influence.

Preferably, the method comprises a step of simple integration of the torque correction variable in order to determine the torque set point.

The invention also relates to a computer program comprising instructions for executing the steps of a control method as presented previously when said program is executed by a computer. The invention also relates to a recording medium of said computer program. The aforementioned recording medium may be any entity or device capable of storing the program. For example, the medium may comprise a storage medium, such as a ROM, for example a CD ROM or a microelectronic circuit ROM, or a magnetic recording medium, for example a hard disk. On the other hand, the recording media may correspond to a transmissible medium such as an electrical or optical signal, which can be conveyed via an electrical or optical cable, radio or other means. The program according to the invention may in particular be downloaded onto an internet-type network. Alternatively, the recording media may correspond to an integrated circuit in which the program is incorporated, the circuit being adapted to execute or to be used in the execution of the method in question.

The invention also further relates to an electronic control unit for turbomachine comprising a memory including instructions from a computer program as presented previously.

The invention also relates to a turbomachine comprising an electronic unit as presented previously.

### BRIEF DESCRIPTION OF THE DRAWINGS

The invention will be better understood upon reading the following description, given as an example, and by referring to the following figures, given as non-limiting examples, wherein identical references are given to similar objects.

FIG. 1 is a schematic representation of a turbomachine according to the prior art,

FIG. 2 is a schematic representation of a system for regulating a fuel flow set point according to the prior art,

FIG. 3 is a schematic representation of a turbomachine according to one embodiment of the invention;

FIG. 4 is a schematic representation of an outlet temperature regulation system according to the invention,

FIG. 5 is a schematic representation of a system for regulating a fuel flow set point and a torque set point according to the invention,

FIG. 6 is a schematic representation of a first fuel regulation loop of the regulation system of FIG. 5,

FIG. 7 is a schematic representation of a second torque regulation loop of the regulation system of FIG. 5.

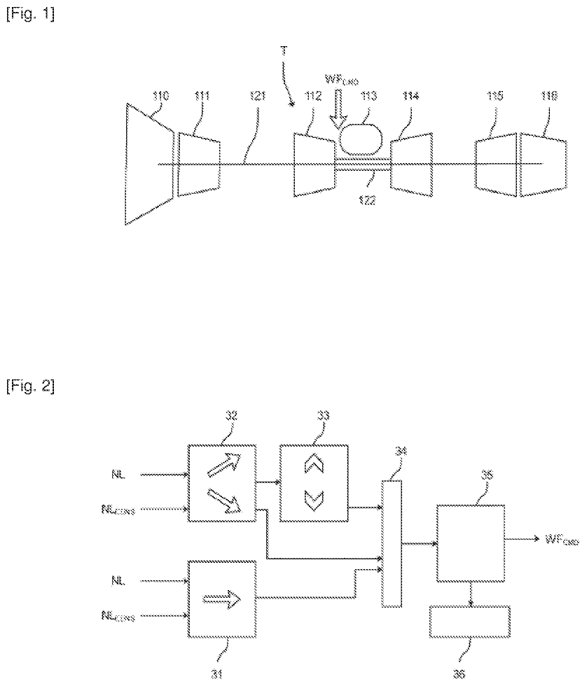

It should be noted that the figures set out the invention in detail in order to implement the invention, said figures may of course be used to better define the invention if necessary.

### DETAILED DESCRIPTION

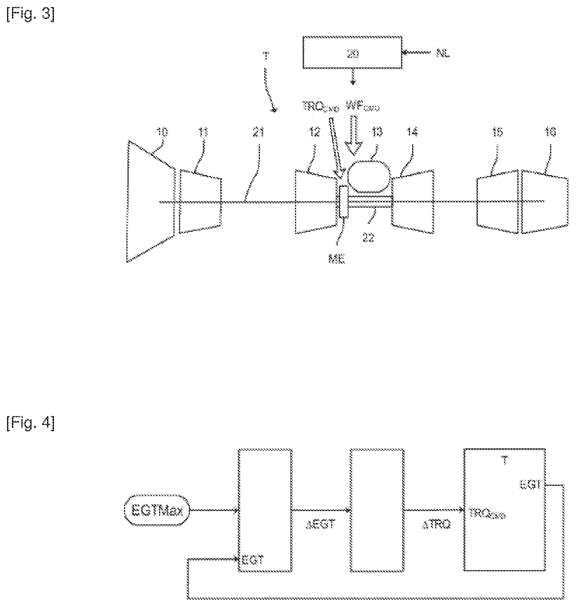

With reference to [FIG. 3], a turbomachine T of the twin-shaft turbofan type for aircraft is schematically represented. In a known manner, the turbomachine T comprises, from upstream to downstream in the gas flow direction, a fan 10, a low pressure compressor 11, a high pressure compressor 12, a combustion chamber 13 which receives a fuel flow set point WF_{CMD}, a high pressure turbine 14, a low pressure turbine 15 and a primary exhaust nozzle 16. The low pressure (or LP) compressor 11 and the low pressure turbine 15 are connected by a low pressure shaft 21 and together form a low pressure body. The high pressure (or HP) compressor 12 and the high pressure turbine 14 are connected by a high pressure shaft 22 and together form, with the combustion chamber 13, a high pressure body. The fan 10, which is driven by the LP shaft 21, compresses the ingested air. This air is divided downstream of the fan between a secondary air flow which is directed directly to a secondary nozzle (not represented) through which it is ejected to contribute to the thrust provided by the turbomachine 100, and a so-called primary flow which enters the gas generator, constituted by the low pressure body and the high pressure body, and which is then ejected into the primary nozzle 16. In a known manner, to modify the speed of the turbomachine T, the aircraft pilot modifies the position of a joystick which makes it possible to modify the fuel flow set point WF_{CMD} in the combustion chamber 13.

With reference to [FIG. 3], the turbomachine T further comprises an electric motor ME configured to provide additional torque to the high pressure shaft 22. The operation of the turbomachine T is controlled by an electronic unit 20 which obtains signals representing operating parameters of the turbomachine T, notably the engine speed NL of the turbomachine T, to provide the fuel flow set point WF_{CMD} and a torque set point TRQ_{CMD} to the electric motor ME. The engine speed NL may correspond to different types of engine speed, notably a fan speed, a pressure set point known as the EPR (Engine Pressure Ratio), a high pressure set point or other.

As illustrated in [FIG. 4], the method comprises a step of determining a temperature correction variable ΔEGT as a function of a temperature parameter of the gases at the outlet of the turbomachine EGT from the turbomachine T and a maximum value of the temperature parameter of the gases at the outlet of the turbomachine EGTMax. The method comprises a step of determining a torque correction variable ΔTRQ as a function of the temperature correction variable ΔEGT and a step of determining the torque set point TRQ_{CMD} as a function of the torque correction variable ΔTRQ.

The electrical torque makes it possible to reduce the outlet temperature EGT advantageously without reducing the overall torque performance, which is advantageous.

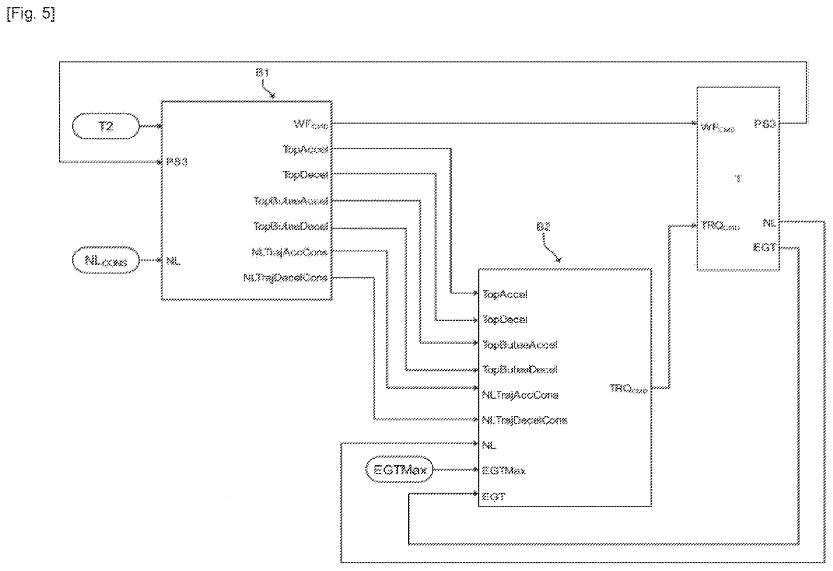

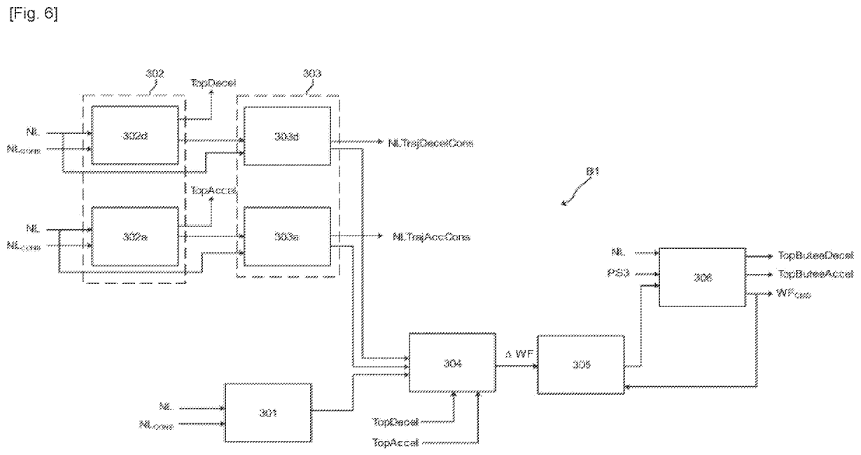

As illustrated in [FIG. 5], the electronic unit 20 comprises a regulation system comprising a first loop B1 for regulating the fuel flow rate set point WF_{CMD}, hereinafter referred to as “first fuel loop B1”, and a second loop B2 for regulating the electrical torque set point TRQ_{CMD}, hereinafter referred to as “second torque loop B2”.

As illustrated in [FIG. 5], the first fuel loop B1 comprises:
a temperature input T2
an engine speed input NL of the turbomachine T
a set point engine speed input NL_{CONS} defined by the position of the joystick that can be handled by the aircraft pilot,
a fuel flow set point output _{CMD}WF transmitted to the turbomachine T and
a plurality of output indicators:
   an indicator of an acceleration transient request TopAccel
   an indicator of a deceleration transient request TopDecel
   an indicator of an acceleration stop TopButeeAccel defined by the saturation of the control of the correctors by the acceleration C/P stop
   an indicator of a deceleration stop TopButeeDecel defined by the saturation of the control of the correctors by the extinction C/P stop
   an engine speed trajectory set point for the acceleration NLTrajAccCons
   an engine speed trajectory set point for the deceleration NLTrajDecelCons

Still with reference to [FIG. 5], the second torque loop B2 receives as input all the output indicators generated by the first fuel loop B1, i.e. TopAccel, TopDecel, TopButeeAccel, TopButeeDecel, NLTrajAccCons, NLTrajDecelCons, as well as the engine speed input NL of the turbomachine T.

According to this exemplary embodiment of the invention, the regulation of the outlet temperature is integrated directly into the second torque loop B2, which makes it possible to consider all the regulations simultaneously,

The second torque loop B2 also receives as input a temperature parameter of the gases at the outlet of the turbomachine EGT (hereinafter the temperature parameter EGT) as well as a maximum temperature value of the gases at the outlet of the turbomachine EGTMax. The parameter EGT is obtained by a sensor of the turbomachine T. Advantageously, thanks to this regulation system, the second torque loop B2 makes it possible to provide an adaptive torque set point TRQ_{CMD} as a function of the behavior of the fuel loop B1 but also of the temperature parameter EGT. In other words, the temperature parameter EGT is integrated directly into the second torque loop B2.

In this example, the first fuel loop B1 also comprises a static pressure input in the combustion chamber PS3.

The structure and the operation of each loop B1, B2 will henceforth be presented in detail.

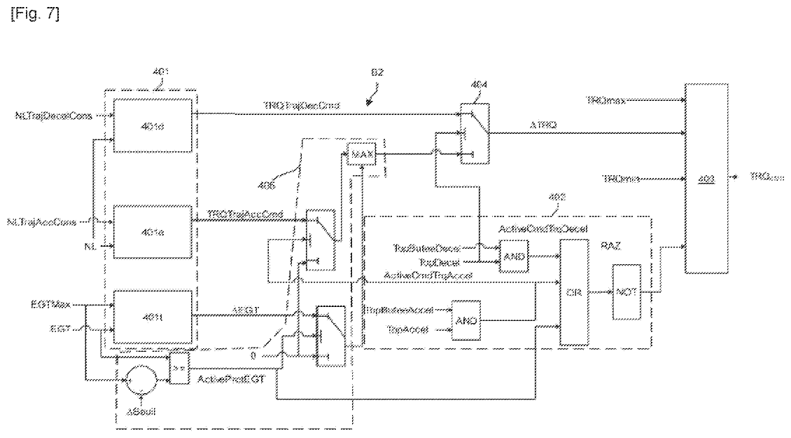

In a known manner, with reference to [FIG. 6], the first fuel loop B1 comprises a stabilized management module 301, a transient intention detection module 302, a module for generating an engine speed trajectory 303, a selection module 304, an integration module 305 as well as a stop management module 306 which fulfills an integration saturation function and therefore the fuel control WF_{CMD}. Such a first fuel loop B1 is known by FR3087491A1.

As will be presented hereafter, the module for generating an engine speed trajectory 303 is also configured to generate a control for the supervision of this trajectory.

The stabilized management module 301 supplies a correction variable to the selection module 304 as a function of the difference between the engine speed NL of the turbomachine T and the set point engine speed NL_{CONS}. Such a stabilized management module 301 is known to those skilled in the art and will not be presented in more detail.

The purpose of the transient intention detection module 302 is to detect a transient intention desired by the pilot. The transient intention detection module 302 determines a difference between the engine speed NL of the turbomachine T and the set point engine speed NL_{CONS}. When the joystick remains in a constant position and the stabilized management module 301 is implemented, the actual speed NL of the turbomachine T is stationary and equal to the set point engine speed NL_{CONS}. If the pilot moves the joystick, the set point engine speed NL_{CONS} varies instantly. On the contrary, the engine speed NL does not vary instantly due to the inertia of the turbomachine T and the stabilized management module 301. Thus, the transient intention detection module 302 detects a transient intention when the difference between the set point engine speed NL_{CONS} and the actual engine speed NL is greater than a predetermined threshold S3.

According to the invention, the transient intention detection module 302 also provides an acceleration transient request indicator TopAccel and a deceleration transient request indicator TopDecel. In the case of an acceleration, if the engine speed difference is greater than the predetermined threshold S3 (NL_{CONS}−NL>S3), the acceleration transient request indicator TopAccel is activated. This function is implemented in an acceleration sub-module 302a which is a comparator. Similarly, in the case of a deceleration, if the engine speed difference is greater than the predetermined threshold S3 (NL−NL_{CONS}>S3), the indicator of a deceleration transient request TopDecel is activated. This function is implemented in a deceleration sub-module 302d which is a comparator. For example, the threshold S3 is 200 rpm.

When a transient phase is detected, the transient intention detection module 302 generates an activation signal, which is transmitted to the engine speed trajectory generation module 303 and the selection module 304 as illustrated in [FIG. 6].

In the case of acceleration, the module for generating an engine speed trajectory 303 determines an engine speed set point for the acceleration (acceleration trajectory) NLTrajAccCons. Similarly, in the case of deceleration, the module for generating an engine speed trajectory 303 determines an engine speed set point NL for the deceleration (deceleration trajectory) NLTrajDecelCons. Such a module for generating an engine speed trajectory 303 is known to those skilled in the art and will not be further presented, in particular, by patent application US2013/0008171. In addition, the generation module 303 is also configured to generate a correction variable, which makes it possible to follow the set point trajectory if required.

In this example, when the selection module 304 receives an activation signal from the transient intention detection module 302, the selection module 304 selects the correction variable from the stabilized management module 301 in the absence of reception of an activation signal and selects the correction variable from the engine speed trajectory generation module 303 in the case of reception of an activation signal. Such a selection module 304 is known to those skilled in the art and will not be presented in more detail.

The selected fuel correction variable AWF is supplied to the integration module 305. The integration module 305 determines the fuel flow set point WF_{CMD} by integrating the fuel correction variable AWF.

The stop management module 306 limits the value of the fuel flow set point WF_{CMD} determined by the integration module 305. In a known manner, the stop management module 306 implements a stop, called C/P stop, known to those skilled in the art. In this example, the stop management module 306 makes it possible to define stop set points in acceleration and deceleration. For this purpose, in the case of an acceleration, the stop management module 306 makes it possible to define an indicator of saturation of the control of the correctors by the acceleration C/P stop TopButeeAccel. Similarly, in the case of a deceleration, the stop management module 306 makes it possible to define an indicator of saturation of the control of the correctors by the extinction C/P stop TopButeeDecel. Such stops are known to those skilled in the art and will not be presented in more detail. Preferably, the stop management module 306 determines the stops as a function of the static pressure in the combustion chamber PS3 and the engine speed NL (high pressure body speed).

As previously stated, such regulation is optimal to limit the fuel set point WF_{CMD} transmitted to the turbomachine T but induces significant response times.

To eliminate this drawback, a second torque loop B2 is coupled to the first fuel loop B1 to determine an optimal torque set point TRQ_{CMD}. To this end, unlike the prior art, the first fuel loop B1 communicates to the second torque loop B2 the different output indicators: TopAccel, TopDecel, NLTrajAccCons, NLTrajDecelCons, TopButeeAccel, TopButeeDecel.

The second torque regulation loop B2 aims to use the electric motor ME sparingly while maintaining control of the temperature parameter EGT. Therefore, a torque set point TRQ_{CMD} is activated only when the trajectories are limited (TopButeeAccel or TopButeeDecel), when the difference between the set point engine speed NL_{CONS} and the actual speed NE indicates a need to activate transient checks (TopAccel or TopDecel) or when the temperature parameter EGT is close to its maximum value EGTMax. Advantageously, as will be presented hereafter, the temperature parameter EGT evolves towards its maximum value EGTMax during an acceleration. The second torque regulation loop B2 relies on the torque control for acceleration (acceleration torque) TRQTraJAccelCmd to regulate the temperature parameter EGT.

As will be presented hereafter, the electrical torque supplied TRQ_{CMD} makes it possible to move the operating point away from the operating limits and thus offer a control margin to adapt once again the fuel set point WF_{CMD}. The electrical torque TRQ_{CMD} supplied also allows the temperature parameter EGT to be moved away from its maximum value EGTMax. Indeed, the electrical torque allows the turbomachine T to be under less load, which leads to lowering its temperature.

Thanks to the invention, the first fuel loop B1 and the second torque loop B2 exchange to improve the operability of the turbomachine T (temperature control, response time, etc.) while limiting the electrical energy consumption by the electric motor ME.

With reference to [FIG. 7], the second torque regulation loop B2 comprises a control determination module 401, a zero reset module 402, an integration module 403, a switch 404 and a processing module 405.

The control determination module 401 comprises:
a current engine speed input NL of the turbomachine
the engine speed set point NL for acceleration (acceleration trajectory) NLTrajAccCons providing a set point variable for torque control
the engine speed set point NL for deceleration (deceleration trajectory) NLTrajDecelCons providing a set point variable for torque control
a temperature parameter EGT input
a maximum temperature value EGTMax.

The control determination module 401 comprises an acceleration sub-module 401a and a deceleration sub-module 401d that are respectively configured to calculate a torque control for acceleration (torque acceleration) TRQTrajAccCmd and a torque control for deceleration (torque deceleration) TRQTrajDecCmd.

In this example, the acceleration sub-module 401a calculates a correction variable for acceleration (acceleration torque) TRQTrajAccelCmd as a function of the speed set point NL for acceleration (acceleration trajectory) NLTraJAccCons, and the current engine speed NL input. The structure of such an acceleration sub-module 401a is known to those skilled in the art. Preferably, the acceleration sub-module 401a is in the form of a pure phase advance type corrector, in particular, a first order high pass. The structure and the function of the deceleration sub-module 401d are similar.

The control determination module 401 further comprises a temperature sub-module 401t which calculates a temperature correction variable ΔEGT as a function of the temperature parameter EGT and its maximum temperature EGTMax. Preferably, the temperature sub-module 401t is in the form of a pure phase advance type corrector, in particular, a first order high pass.

With reference to [FIG. 7], the processing module 405 further comprises a comparator configured to compare the temperature parameter EGT with the maximum temperature value EGTMax decreased by a predetermined adjustment threshold ΔSeuil. When the temperature parameter EGT is too close to the maximum temperature value EGTMax, a temperature protection control ActiveProtEGT is activated. The temperature protection control ActiveProtEGT makes it possible to activate the temperature correction variable ΔEGT,

The predetermined adjustment threshold ΔSeuil is determined during tests as a function of the regulation response time and the overrun that it is allowed to have on the temperature parameter EGT. The greater the temporary overrun permitted and/or the faster the loop response time, the lower the adjustment threshold ΔSeuil is set.

The processing module 405 comprises in addition a max switch that makes it possible to select the maximum value between the temperature correction variable ΔEGT and the acceleration correction variable TRQTrajAccCmd in order to satisfy the highest constraint for the torque input. In other words, during an acceleration request, the electric motor ME also makes it possible to regulate the temperature parameter EGT while avoiding loading the turbomachine T.

With reference to [FIG. 7], the selection of the control before integration by the integration module 403 is ensured by a switch 404 in order to select the deceleration control in deceleration or the acceleration control in acceleration.

The zero reset module 402 comprises a plurality of input indicators from the first fuel loop B1:
the indicator of an acceleration transient request TopAccel
the indicator of a deceleration transient request TopDecel
the indicator of an acceleration stop TopButeeAccel defined by the saturation of the control of the correctors by the acceleration C/P stop
the indicator of a deceleration stop TopButeeDecel defined by the saturation of the control of the correctors the extinction C/P stop.

The zero reset module 402 aims to reset to zero the torque control TRQ_{CMD} via the resetting to zero of the integrator 403. As will be presented hereafter, the resetting to zero is not abrupt but progressive. The zero reset module is implemented continuously. Nevertheless, the zero reset is inhibited:
when an acceleration is requested and when the acceleration stop is already reached (TopAccel and TopButeAccel activated) (ActiveCmdTrqAccel status)
when a deceleration is requested and the deceleration limit is already reached (TopDecel and TopButeeDecel activated) (ActiveCmdTrqDecel status) or
when a temperature protection control ActiveProtEGT is activated.

When the fuel set point WF_{CMD} of the first fuel loop B1 wishes to deviate from the permitted operating range, the reset to zero module 402 is not reset to zero. Thus, the torque set point TRQ_{CMD} makes it possible to move the operating point away from the operating limits. A resetting to zero of the torque control TRQ_{CMD} is only initiated when a regulation by the fuel set point WF_{CMD} is possible.

In other words, the second torque loop B2 acts synergistically with the first fuel loop B1. The second torque loop B2 supports the first fuel loop B1. In stabilized engine speed, the torque set point TRQ_{CMD} is thus reset to zero to limit electrical power consumption and preserve the lifetime of the electric motor ME.

With reference to [FIG. 7], the integration module 403 comprises:
a correction input receiving a torque correction variable ΔTRQ from the switch 404
a maximum torque value TRQmax determined by the structure of the electric motor ME, TRQmax representing the maximum controllable motor torque (positive by convention) for the electric motor ME
a minimum torque value TRQmin determined by the structure of the electric motor ME, TRQmin representing the maximum controllable braking torque (negative by convention) for the electric motor ME
a zero reset input RAZ provided by the zero reset module 402
a torque set point output TRQ_{CMD}.

Preferably, the minimum torque value TRQmin and the maximum torque value TRQmax of the electric motor ME are not necessarily constants and may be laws that are functions of various parameters making it possible to make the best use of the operating limits of the electric motor ME.

In this example, the integration module 403 is a simple integrator, in order to integrate the torque connection variable ΔTRQ. This makes it possible to ensure a permanent zero speed error, and therefore a pre-determined acceleration or deceleration time. In practice, a class 1 corrector for the control is sufficient to cancel the trajectory following error thanks to the effect combined with the fuel control. The supervision stability is advantageously improved by eliminating the phase shift effect of −90° induced by one of the integrators.

The removal of the torque TRQ provided by the electric motor ME must be compensated simultaneously by an adaptation of the fuel set point WF_{CMD}, otherwise a disturbance of the engine speed NL would be systematic. Advantageously, the adaptation of the fuel set point _{CMD}WF is automatic and will be compensated by the first loop B1 as long as the reset to zero control of TRQ_{CMD} is suppressed sufficiently slowly so as not to exceed the bandwidth of the first loop B1.

An exemplary embodiment of a method for controlling a turbomachine in which a fuel flow set point WF_{CMD} and an electrical torque set point TRQ_{CMD} are determined will now be presented.

For example, when the pilot handles the joystick to increase the engine speed of the turbomachine T, the first regulation loop B1 detects, via the transient intention detection module 302, an engine speed transient and issues an indicator of an acceleration transient request TopAccel. Similarly, the module for generating an engine speed trajectory 303 determines an engine speed set point for the acceleration (acceleration trajectory) NLTrajAccCons. The acceleration trajectory is in the form of a slope. In addition, the stop management module 306 limits the fuel flow set point value WF_{CMD} and defines an acceleration stop set point TopButeeAccel which imposes a maximum fuel set point QMAX.

When the temperature parameter EGT approaches its maximum value EGTMax, a correction value ΔEGT is calculated and compared with the acceleration correction value TRQTrajAccCmd. The maximum correction value chosen between ΔEGT and TRQTrajAccCmd is provided to the comparator 404 in order to activate the electric motor ME to reactively reduce the temperature of the outlet gases of the turbomachine T. In other words, the present invention provides an acceleration correction value optimized to take into account the temperature parameter EGT. Thus it is not necessary to entirely modify the regulation system to regulation the temperature parameter EGT.

Thanks to the invention, the electric motor ME is used sparingly to make it possible to follow an optimal trajectory, making it possible to offer a margin to regulate the fuel set point WF_{CMD} while maintaining control of the temperature parameter EGT. The first fuel loop B1 and the second torque loop B2 are implemented synergistically to optimize the following of the engine speed trajectory and thus improve the operability of the turbomachine T.

A regulation of the temperature has been presented in the case of an acceleration, but it may also occur during full throttle operation or when taking off.

1-10. (canceled)

11. A method for controlling a turbomachine comprising a fan positioned upstream of a gas generator and delimiting a primary flow and a secondary flow, said gas generator being crossed by the primary flow and comprising a low pressure compressor, a high pressure compressor, a combustion chamber, a high pressure turbine and a low pressure turbine, said low pressure turbine being connected to said low pressure compressor by a low pressure rotating shaft and said high pressure turbine being connected to said high pressure compressor by a high pressure rotating shaft, and an electric motor forming a torque injection device on the high pressure rotating shaft, the control method comprising:
a step of determining a fuel flow set point in the combustion chamber and a torque set point supplied to the electric motor;
a step of determining a temperature correction variable as a function of a turbomachine outlet gas temperature parameter and a maximum value of the turbomachine outlet gas temperature parameter;
a step of determining a torque correction variable as a function of the temperature correction variable; and
a step of determining the torque set point as a function of the torque correction variable.

12. The method according to claim 11, wherein the control method comprises:
a step of implementing a first fuel regulation loop in order to determine the fuel flow set point comprising:
a step of detecting an engine speed transition intention as a function of a difference between a current engine speed and a determined engine speed set point,
a step of determining a transition engine speed set point,
a step of determining a fuel correction variable as a function of the transient engine speed set point, and
a step of determining the fuel flow set point as a function of the fuel correction variable,
a step of implementing a second torque regulation loop in order to determine the torque set point comprising:
a step of determining a torque correction variable as a function of the transient engine speed set point and the temperature correction variable.

13. The control method according to claim 11, wherein, during the step of determining a torque correction variable, the maximum value is selected between the temperature correction variable and an acceleration correction variable determined from the acceleration transient engine speed set point.

14. The control method according to claim 11, comprising:
a step of activating a temperature protection control by comparing the turbomachine outlet gas temperature parameter with the maximum value of the turbomachine outlet gas temperature parameter reduced by a predetermined adjustment threshold
a step of activating the temperature correction variable when the temperature protection control is activated.

15. The control method according to claim 13, comprising:
during the step of implementing the second torque regulation loop, a step of resetting to zero the torque set point, the step of resetting to zero the torque set point being inhibited in case of activation of the temperature protection control.

16. The control method according to claim 15, wherein the torque set point is progressively reset to zero.

17. The control method according to claim 11, comprising a step of simple integration of the torque correction variable in order to determine the torque set point.

18. A computer program comprising instructions for executing the steps of the control method according to claim 11 when said program is executed by a computer.

19. The electronic control unit for turbomachine comprising a memory including instructions of a computer program according to claim 18.

20. The turbomachine comprising an electronic unit according to claim 19.
